(19) United States
(12) Patent Application Publication
(10) Pub. No.: US 2002/0047252 A1
(43) Pub. Date: Apr. 25, 2002

(54) Supplemental restraint system

(76) Inventor: Hoon Y. Kim, Chicago, IL (US)

Correspondence Address: Welsh & Katz Ltd., Daniel M. Gurfinkel, 22nd Floor, 120 South Riverside Plaza, Chicago, IL, 60606, US

(21) Appl. No.: 09/968,066

(22) Filed: Oct. 1, 2001

Related U.S. Application Data
(60) Provisional application No. 60/236,854, filed on Sep. 29, 2000.

(51) Int. Cl. B60R 21/16

(52) U.S. Cl. 280/728.1

(57) ABSTRACT

A supplemental restraint system that is easy to use and provides superior protection in an automobile is provided. The user of the system is prevented from the damaging effects of being restrained by a shoulder seat belt combination that provides inadequate support to most of the body and can produce injury at the point of contact with the body during an accident. Further, the supplemental restraint system of the present invention provides the user with an air bag that travels with the user and deploys away from the user such that the user is not harmed by the typically violent explosion of an air bag during an accident and yet receives the full cushioning benefit of an air bag in an accident. The present invention provides a means of dressing an adult or a child in a restraint jacket that may be easily attached within a vehicle and provides the user with an air bag and other restraints that fit the user's height and weight requirements.

### FIELD OF THE INVENTION

The present invention concerns a novel collision survival system for automobiles, specifically the present invention concerns a restraint jacket that combines the function of both an air bag and a seat/shoulder belt system.

### BACKGROUND

There are approximately 3.2 million fatalities and injuries in the United States every year related to automobile accidents. Medical expenses for the 3.2 million injuries and fatalities amount to approximately $150 billion, exclusive of property damages. Among the 3.2 million fatalities and injuries are approximately 180,000 children under the age of nine.

Currently, safety equipment in automobiles includes the following:

Seat Belts:

Current seat belts are designed to be used in automobiles at any time that an automobile is running. Often times, automobile riders do not use their seat belts, generally due to neglect. Further, in case of collision, it has been found that seat belts alone do not provide sufficient protection. It has been determined that certain body parts are not protected by seat belts during collisions, for example, seat belts cannot protect the neck or head area. Also, when seat belts are worn in a collision, the belts cause severe impacts to the body in the areas where they are worn, specifically across the shoulder and belly area.

Air Bags:

Most modern automobiles are provided with air bags. The standard placement of air bags is on the dashboard of the vehicle, generally facing the occupant. When an air bag deploys it typically explodes towards the passenger with great speed and force. Air bags have been known to deploy when not needed, such as when there has not been an accident or when there has been such a slight accident which as not to have required the deployment of the air bag. The deployment of air bags in such cases and in cases of accidents have been known to cause injuries and even fatalities. Further, in cases of severe collisions, air bags have been known to cause severe injury or death to small adults and to children. In addition, the chemical used to inflate the air bag, sodium azide, has been found to be unsafe for some passengers.

Child Restraint Systems:

Most states require that children of a certain age or size be placed in child restraint seats in automobiles. For newborn children and small toddlers the restraints include seats that face towards the rear of the vehicle known as infant car seats. Older children are required to be places in larger forward facing child restraint seats or car seats and/or booster seats. The requirements for booster seats have recently been found to be necessary for older children who are generally smaller, as the booster seat elevated the child so as to allow a standard seat and shoulder belt to lie correctly on the shoulder and mid- section of the smaller child.

The most common problem with these child restraint seats is the fact that most parents do not use the seats properly. When not used properly, these child restrain systems do not protect the child, may be ineffective in preventing injury or death in an accident and can result in injury to the child. These problems could be solved if parents use the child restraints properly. However, because there are a number of manufacturers of these seats and each manufacturer may utilize a different system of securing the seat to the automobile, it is often difficult for parents and others to know how to properly attach the seat.

### SUMMARY OF THE INVENTION

The present invention concerns a supplemental restraint system for use in an automobile comprising, a jacket having restraints for attachment to the seat of an automobile. The jacket, which may be of a variety of types, including a series of braces and bars resembling a safety cage, or a typical cloth jacket worn as a garment. The jacket is wearable by a rider in the automobile such that when the rider wears the jacket the rider is secured to the seat of the automobile so that the rider remains secured against the seat of the automobile notwithstanding the motion of the automobile.

In one embodiment, the supplemental restraint system has restraints that comprise a sleeve attached to the jacket, the sleeve being slideable over the back portion of the seat. In this manner, the back of the seat of the vehicle provides bracing force to the jacket. In an embodiment where the jacket resembles an ordinary cloth jacket, extra material may be added to the back panel of the jacket to provide the slideable sleeve.

In another embodiment, the restraints comprise belts, having buckles, attached to the jacket and buckled together about the seat.

In another embodiment the jacket includes air bags, and air bag discharge sensors, strategically placed such that motions which typically cause automobile air bags to deploy cause the jacket air bags to deploy. Further, in one embodiment, the jacket air bags are strategically placed on the jacket to provide needed restraint in an air bag deployment incident. Also, in such embodiment, the deployment of the jacket air bags occurs or expands in a direction not diametrically opposite to the movement of the jacket such that the bag does not strike the user of the supplemental restraint system head-on. In this embodiment, an air bag that is placed on or near the chest portion of the jacket deploys in the direction that the user is travelling so that the user is not struck by the air bag. This embodiment has the added benefit of providing air bag protection for an automobile that does not have air bags built into the automobile.

In another embodiment, the jacket may be separated from the automobile, such that it may be worn as an ordinary jacket when the user is away from the automobile, and may be reattached upon returning to the automobile.

The present invention provides a seat belt and supplemental restrain system that include bars and straps that keep a passenger in his seat and which includes a number of air bags, in association with the bars and straps, such that one or more air bags will, upon vehicle impact, inflate upon and about the passenger rather than towards the passenger. In the preferred embodiment of the present invention, means to attach a restraint jacket to the automobile seat are provided. The passenger may be seated within the jacket and, thus, be provided with a number of belts, bars and surrounding air bags, such that injury will be prevented by keeping the passenger in his seat and providing cushioning air bags to surround and protect the passenger. It is to be understood that the restraint jacket of the present invention may be provided with crash detection sensing devices and may be connected to the vehicle in such a fashion as to utilize crash sensors present in the vehicle and/or which are well known to persons having skill in the art.

In a further embodiment of the present invention a supplemental restraint system which resembles an ordinary jacket, such as a leather jacket or a wind breaker, is envisioned. The jacket has means for sensing that an accident or impact has occurred, or has means to attach the jacket to external sensors or to the sensors conventionally found in a vehicle. The passenger puts the jacket on, in the way one would normally put a jacket on, and sits in the vehicle. The restraint system built into the jacket, including a means to attach the person to the vehicle seat, such as a wide band of jacket material (which can be as wide and tall as the entire back area of the jacket) is slid over the vertical portion of car seat-back, so as to restrain the person in the seat, and air bags, are built into the jacket.

The supplemental restraints of the present invention provide a means to protect the passenger with a system that is as easy to use as putting on a jacket.

The reason for the present invention is to provide a solution to the problems found in prior art seat belts, air bags and child restraint systems.

When air bags deploy, the speed and direction of the air bag is directly in the reverse direction of travel of the vehicle and the passengers. Accordingly, the impact on a passenger will be the sum of the speed of the vehicle at the moment of impact and the speed of the air bag as it deploys towards the passenger. For example, if the vehicle is traveling at approximately 50 kilometers per hour forward and the air bag deploys at approximately 30 kilometers per hour towards the passenger, then the passenger will feel an impact equal to an approximately 80 kilometer per hour impact. In the present invention, the moving speed and direction of passengers will be almost the same as the moving direction of the air bag deployed, thereby giving the passenger an almost zero extra impact from the air bag deployment.

Further, due to the design of seat belts, passengers are not protected fully and may be injured at the points of contact with the seat and shoulder belt on the body. The new design solves these problems by providing restraint over a wider area. In one case, bars and straps are used to restrain the passenger to the seat, in one embodiment, and in another embodiment, the passenger may be restrained though out his entire back.

A more detailed explanation of the invention is provided in the following description and claims and is illustrated in the accompanying drawings.

### BRIEF DESCRIPTION OF THE DRAWINGS

FIG. 1 is a schematic view of an automobile accident showing the results of an accident in an automobile having restraint systems of the prior art.

FIG. 2 is a schematic view of an automobile accident showing the results of an accident in an automobile having a restraint system of the present invention.

FIG. 3 is a schematic view of an automobile accident showing the results of an accident in an automobile having a restraint system of another embodiment of the present invention.

FIG. 4 is a perspective view of a supplemental restraint system of the present invention.

FIG. 5 is a perspective view of the supplemental restraint system of FIG. 4 placed on an automobile seat and being used by a person.

FIG. 6 is perspective view of the supplemental restraint of FIG. 5 in a deployed position.

FIG. 7 is a perspective view of another embodiment of the supplemental restraint system of the present invention.

FIG. 8 is another view of the supplemental restraint system of FIG. 7.

FIG. 9 is a perspective view of another embodiment of the supplemental restraint system of the present invention.

FIG. 10 is another view of the supplemental restraint system of FIG. 9.

### DETAILED DESCRIPTION OF THE ILLUSTRATIVE EMBODIMENT

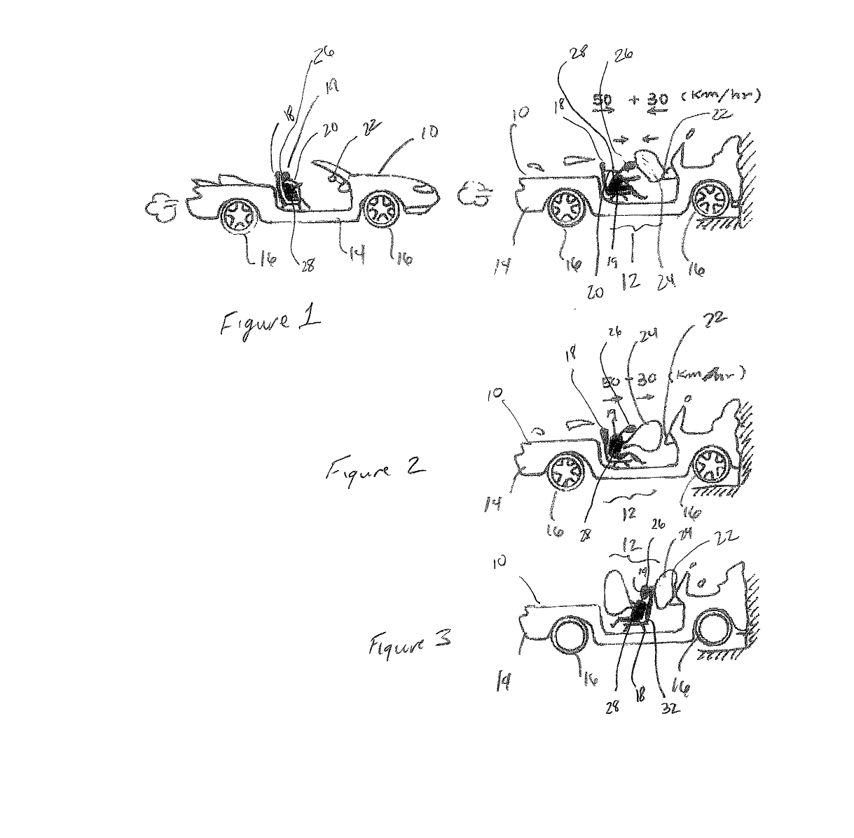

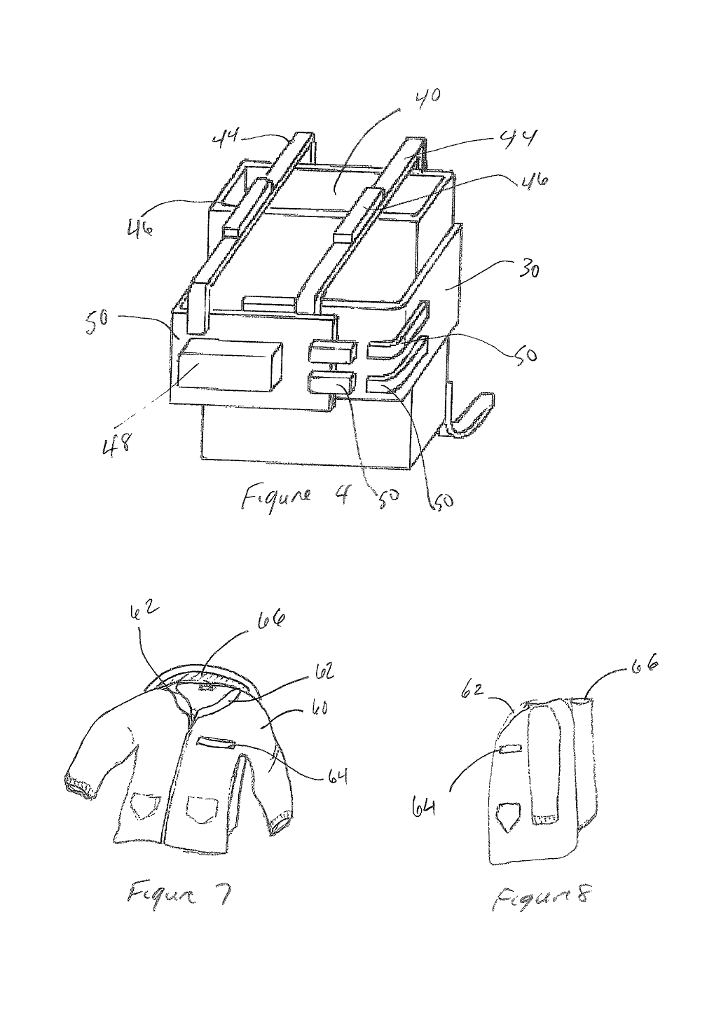

Referring to the drawings, FIGS. 1 through 3 show, schematically, the results of an accident in a vehicle 10 equipped with the restraint systems 12 of the prior art (FIG. 1), and of the present invention (FIGS. 2 and 3). Vehicle 10 comprises a body 14, wheels 16 a passenger seat 18, a shoulder and seat belt 20 a steering wheel 22 and an air bag 24. As can be seen in FIG. 1, the impact of an accident in a vehicle 10 traveling at a speed of 50 kph at the moment of impact, causes the deployment of air bag 24, generally at 30 kph, out of steering wheel 22 towards the passenger 19. As a result of the accident, passenger 19 is thrown forward by the inertia of the accident and is held by belt 20. It may be seen in FIG. 1, that passenger 19 has had its head 26 thrown forward by the impact an because passenger's 19 torso 28 has been restrained by belt 20.

FIG. 2 shows a similar accident in a vehicle 10 equipped with the supplemental restraint of the present invention. As can be seen, passenger 19 is restrained against seat 28 by the jacket 30, shown in FIG. 6, of the present invention. Head 26 is thrown forward, however, it is restrained from striking steering wheel 22 (or the dash board or other surface for such a system deployed in the front passenger or other seating location in the vehicle) by air bag 24. In the device of the present invention, however, air bag 24 does not travel towards passenger 19, but instead travels with passenger 19, such that upon deployment, away from passenger 19, passenger 19's head 26 is gently supported by air bag 24. FIG. 3 shows another embodiment, wherein the passenger travels in a special seat 32, which allows passenger 19 to face away from the general direction of travel. Such travel has been found to be safer than forward facing travel, and in combination with the supplemental restraint of the present invention, provides an extremely safe manner of travel.

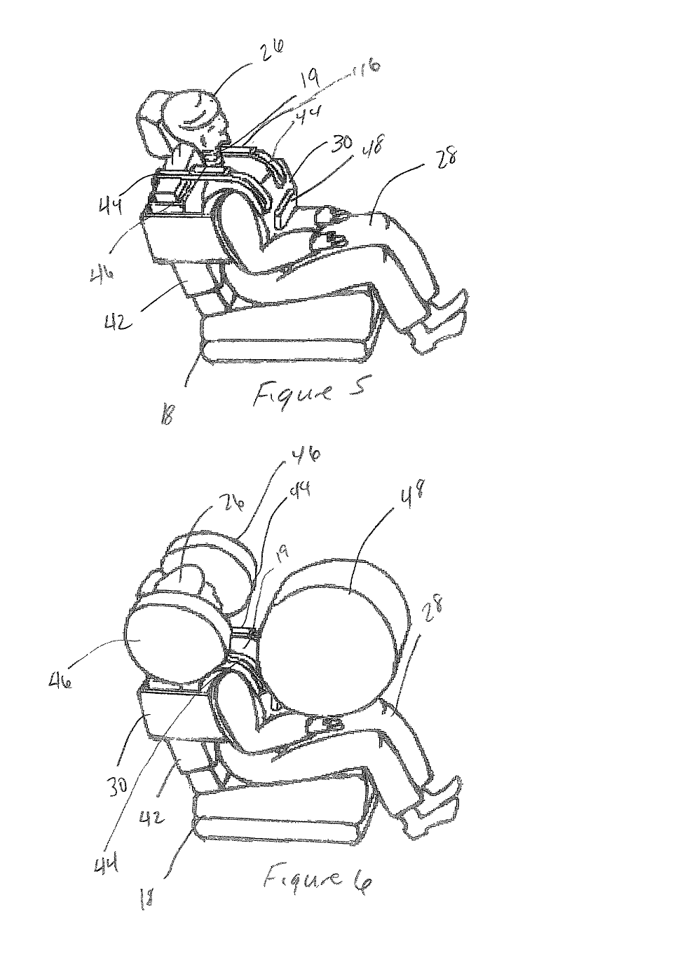

Referring now to FIG. 4, a restraint jacket 30 is shown. Restraint jacket 30 comprises a seat back sleeve 40, which in operation is placed onto the seat back 42 of a vehicle seat 18 (FIG. 5). Restraint jacket 30 further comprises shoulder bars 44 having head protection air bags 46 and main air bag 48. A system of jacket securing means 50 are also provided, as are means to anchor jacket 30 to a vehicle. FIG. 5 shows the placement of jacket 30 onto a vehicle seat and the position of jacket 30 on a person. FIG. 6 shows jacket 30 in a deployed condition, with air bags 46 and 48 deployed.

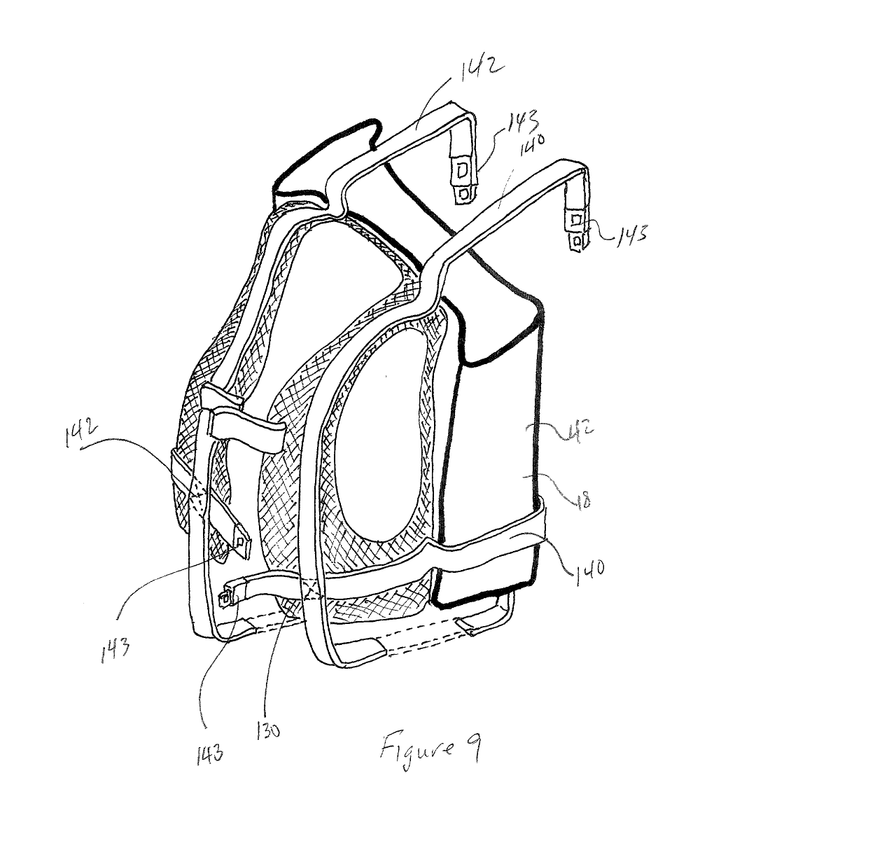

FIGS. 7 and 8 show a more conventional jacket 60 which provides similar protection as jacket 30, but which may be worn as a wind breaker or other jacket when not used in a vehicle. It is noted that for small children, jacket 60 allows the child to be dressed at home, and then installed into the vehicle, while being worn, such that placement of a child into a safe restraint system is almost as easy as placing a child onto a seat. Jacket 60 further comprises head protection air bags 62 and a main body air bag 64. Jacket 60 may be fashioned such that it may be closed using buttons or a zipper in a conventional manner. It is envisioned that various types of materials, including leather, vinyl, nylon, wool, cotton and other man made and natural fabrics may be used in the construction of jacket 60, such that jacket 60 is functional, comfortable (in all weather conditions) and stylish, without departing from the novel scope of the present invention. Jacket 60 further comprises a back sleeve 64 for securing jacket 60 and passenger 18 to a car seat in a manner similar to that illustrated in FIG. 5. It is envisioned that sleeve 64 may be made of the same material as jacket 60, so as to hide sleeve 60 when the jacket is worn away from the vehicle or may be made of contrasting materials, colors, or textures, to create a fashion statement of its own, all without departing from the novel scope of the present invention. Sleeve 64 may also be made such that it may be detached from jacket 60 is such a manner as to not effect the integrity of the restraint system of the present invention.

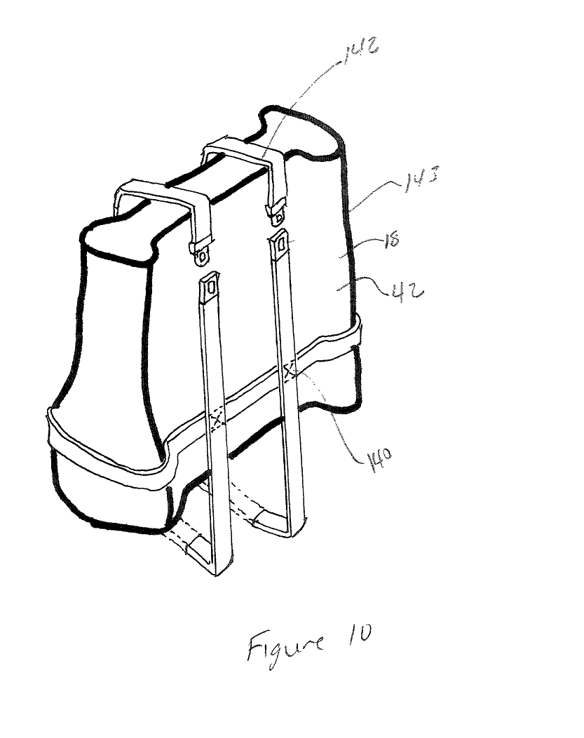

Referring now to FIGS. 9 and 10, another embodiment of the restraint jacket 130 of the present invention is shown. Restraint jacket 130 comprises a seat back strap system 140, which comprises a number of straps 142, having buckling mechanisms 143, attached to jacket 130 and arranged such that in operation jacket 130 may be placed onto the seat back 42 of a vehicle seat 18 (shown more clearly in FIG. 5). In this manner, restraint jacket 130 may be anchored to the car 10 through seat back 42. In a further embodiment of the present invention, the restraint jacket 130 further comprises shoulder bars having head protection air bags and main air bag, as shown and described with respect to FIGS. 4 and 5. In this manner, jacket 130 may be equipped with supplemental restraint systems similar to those described above.

Although illustrative embodiments of the invention have been shown and described, it is to be understood that various modifications and substitutions may be made by those skilled in the art without departing from the novel spirit and scope of the invention.

What is claimed is:

1. A supplemental restraint system for use in an automobile comprising:
a jacket having restraints for attachment to the seat of an automobile;
the jacket being wearable by a rider in the automobile such that when the rider wears the jacket the rider is secured to the seat of the automobile such that the rider remains secured against the seat of the automobile notwithstanding the motion of the automobile.

2. The supplemental restraint system of claim 1, wherein the restraints comprise a sleeve attached to the jacket and slideable over the back portion of the seat.

3. The supplemental restraint system of claim 1, wherein the restraints comprise belts, having buckles, attached to the jacket and buckled together about the seat.

4. The supplemental restraint system of claim 1, wherein the jacket includes air bags, and air bag discharge sensors, strategically placed such that motions which typically cause automobile air bags to deploy cause the jacket air bags to deploy.

5. The supplemental restraint system of claim 4, wherein the jacket air bags are strategically placed on the jacket to provide needed restraint in an air bag deployment incident.

6. The supplemental restrain system of claim 4, wherein the deployment of the jacket air bags occurs in a direction not diametrically opposite to the movement of the jacket such that when the air bag is deployed the air bag expands in a direction away from the wearer of the jacket.

7. The supplemental restraint system of claim 4, wherein an airbag is provided at or in the chest area of the jacket such that when the air bag is deployed it is deployed in the direction of travel.

8. The supplemental restraint system of claim 1, wherein the jacket may be separated from the automobile, such that it may be worn as an ordinary jacket when the user is away from the automobile, and may be reattached upon returning to the automobile.

9. A supplemental restraint system for use in an automobile comprising:
a jacket having restraints for attachment to the seat of an automobile;
the jacket including air bags, and air bag discharge sensors, strategically placed such that motions which typically cause automobile air bags to deploy cause the jacket air bags to deploy;
the jacket being wearable by a rider in the automobile such that when the rider wears the jacket the rider is secured to the seat of the automobile such that the rider remains secured against the seat of the automobile notwithstanding the motion of the automobile; and, the deployment of the jacket air bags occurs in a direction not diametrically opposite to the movement of the jacket such that a deployed air bag expands in a direction away from the wearer of the jacket.

10. The supplemental restraint system of claim 9, wherein the restraints comprise a sleeve attached to the jacket and slideable over the back portion of the seat.

11. The supplemental restraint system of claim 9, wherein the restraints comprise belts, having buckles, attached to the jacket and buckled together about the seat.

12. The supplemental restraint system of claim 9, wherein the jacket air bags are strategically placed on the jacket to provide needed restraint in an air bag deployment incident.

13. The supplemental restraint system of claim 9, wherein the jacket may be separated from the automobile, such that it may be worn as an ordinary jacket when the user is away from the automobile, and may be reattached upon returning to the automobile.
